(19) United States
(12) Patent Application Publication
(10) Pub. No.: US 2005/0197895 A1
(43) Pub. Date: Sep. 8, 2005

(54) Method and assembly for card and internet connection having common theme

(76) Inventor: Bruce Alan Faulk, Los Angeles, CA (US)

Correspondence Address: Thomas A. Turner, Jr., 11377 West Olympic Boulevard, Los Angeles, CA, 90064, US

(21) Appl. No.: 10/791,641

(22) Filed: Mar. 3, 2004

(51) Int. Cl. G06F 17/60

(52) U.S. Cl. 705/14

(57) ABSTRACT

An interactive card assembly includes a card and an electronically readable storage device designed for interactive connection to the Internet, the card and the storage device having information with a common theme and the storage device having stored information capable of connecting on the Internet with predetermined homepages having the common theme. A method for presenting Internet addresses and connecting to the homepages represented by the addresses using the elements of the interactive card assembly is described.

### BACKGROUND OF THE INVENTION

1. Field of the Invention

The present invention relates to the art of communication, and more particularly to the art of thematic communications and Internet connections having a common theme.

2. Description of the Prior Art

In the past, it has been known to provide greeting cards having a particular theme. Examples of such themes are birthday greetings, graduation greetings, condolences, congratulations and the like. It has been known to provide such cards having ancillary items inserted into or packaged with the card. Such items as phonograph records, musical compact disks, reply cards, card stock assemblies popularly known as “pop-up,” pencils, medallions and like items have been known to be included with such cards.

It is an object of the present invention to provide a card in conjunction with a compact computer disk (“CD”) capable of being read by a computer having a display monitor or screen, such as a personal computer, to display information from the CD on the screen, where the information on the CD has a common theme with the indicia on the card. It is a further object of the present invention to provide such a CD with the card, where the information on the CD can be used in conjunction with the indicia on the card to present a video presentation which extends the emotional context to the theme of the card. It is yet a further object of the present invention to provides such a CD with the card, where the information on the CD can be used in conjunction with the indicia on the card to present and to construct puzzles and games consistent with the theme of the card. It is yet a further additional object of the present invention to provide such a CD with the card, where the CD has embedded data on the CD which will, upon activation, establish a hyperlink to a World Wide Web Internet (“Internet”) address, the subject matter of which address will be related in some common theme with the theme of the card, such as, for example, addresses of “on-line” sellers of theme related products and services.

It is still yet another object of the present invention to provide a method of combining the card with the CD and accessing an Internet address the subject matter of which has a common theme with the card's indicia.

### SUMMARY

In brief, in accordance with one aspect of the present invention, a card having a predetermined theme has a computer readable CD on which information and data relating to the theme of the card is readably stored. The CD also has Internet addresses embedded thereon which, when the CD is inserted into a computer connected to the Internet, a simple click on the embedded address will connect and display on the computer screen the information available at the selected Internet address.

The card having predetermined thematic indicia on it is sent with a CD having common thematic information embedded thereon, and having interactive Internet addresses of organizations that have common subject matter, to include, e.g., related products and services, with the theme of the card and the information stored on the CD. At the receiving end, the recipient inserts the CD into a computer having Internet connection capability. The information on the CD is displayed on the computer's screen or monitor. The displayed information may also include predetermined interactive information, theme related entertainment, games, and puzzles. Among the interactive information are the Internet addresses of the organizations that have common subject matter with the theme common to the card and to the CD. By interactively selecting one of the embedded addresses displayed, access can be had by the recipient of the present invention, to other organizations that can provide enormous additional information, products and services related to the subject matter of the common theme. Moreover, the recipient can be interactively connected with such addressed organizations to study, to be informed, to be entertained, to purchase and to feed back information to the addressed organization.

These and other novel aspects of the present invention, together with other aspects thereof, can be better understood by the following detailed description of the preferred embodiments, which are designed to be read in conjunction and together with the accompanying drawings.

### BRIEF DESCRIPTION OF THE DRAWINGS

FIG. 1 is a perspective view of the card and CD assembly of the preferred embodiment of the present invention, having the card slightly opened partially showing the CD;

FIG. 2 is a perspective view of the preferred embodiment of FIG. 1 taken from the opposite direction of the view of FIG. 1;

FIG. 3 is a perspective view of the preferred embodiment of FIG. 1 showing the card assembly in a closed position;

FIG. 4 is a perspective view of the preferred embodiment of FIG. 1 showing the card assembly in a closed position as seen from the opposite side in the view of FIG. 3;

FIG. 5 is a perspective schematic view of the preferred embodiment of the present invention when being used in conjunction with computer connected to the Internet; and,

FIG. 6 is a block diagram showing the method of the preferred embodiment of the present invention.

### DETAILED DESCRIPTION OF THE PREFERRED EMBODIMENT

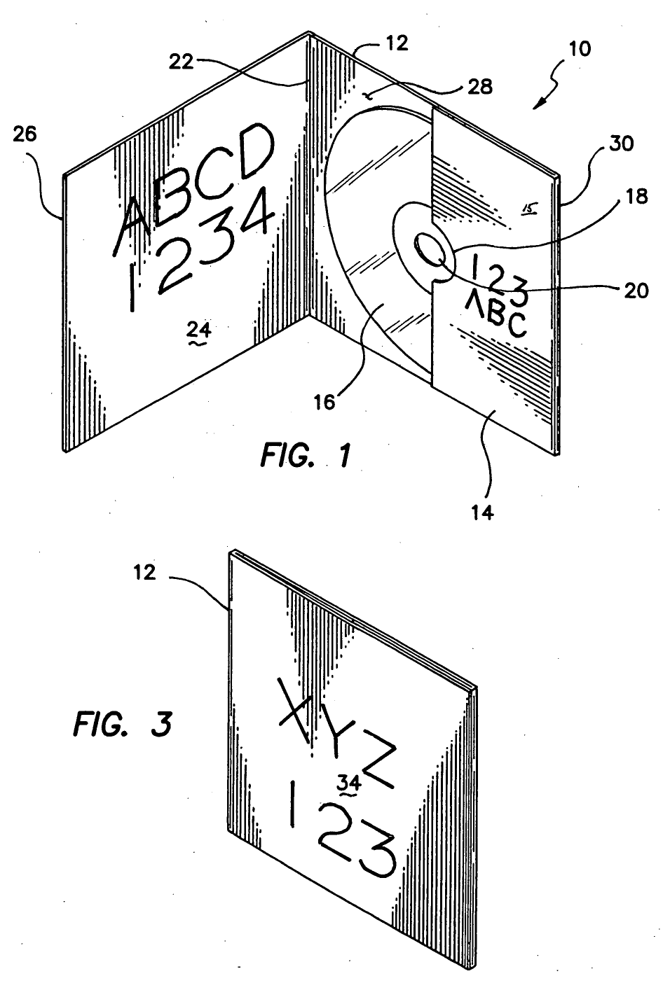

A card and disk assembly 10 comprises a card 12 and a disk 16 packaged together, reference being initially to FIG. 1 of the accompanying drawings where reference numerals refer to like reference numerals used herein. The card 12 has a pocket 14 formed by an overlap. The disk 16 is held within the card 12 by inserting the disk 16 into pocket 14. The pocket 14 has a cut-out 18 to expose a disk center hole 20, and make the center hole 20 easily accessible to a finger for extracting the disk 16 from the pocket 14. The pocket 14 has a surface 15 on which indicia may be printed, as shown in FIG. 1.

The card has a folding line 22 about which the card 12 is divided into two leaves. A planar inside surface 24 of a front leaf 26 is designed to have indicia and text printed thereon. A second or back leaf 30 has an inside surface 28, as shown. As may be seen better in FIG. 2 of the drawings, the front leaf 26 has an outside surface 34 on which indicia and text may also be imprinted. The back leaf 30 also has an outside surface 36. The folding line 22 shows the general orientation of the card 12 when unfolded.

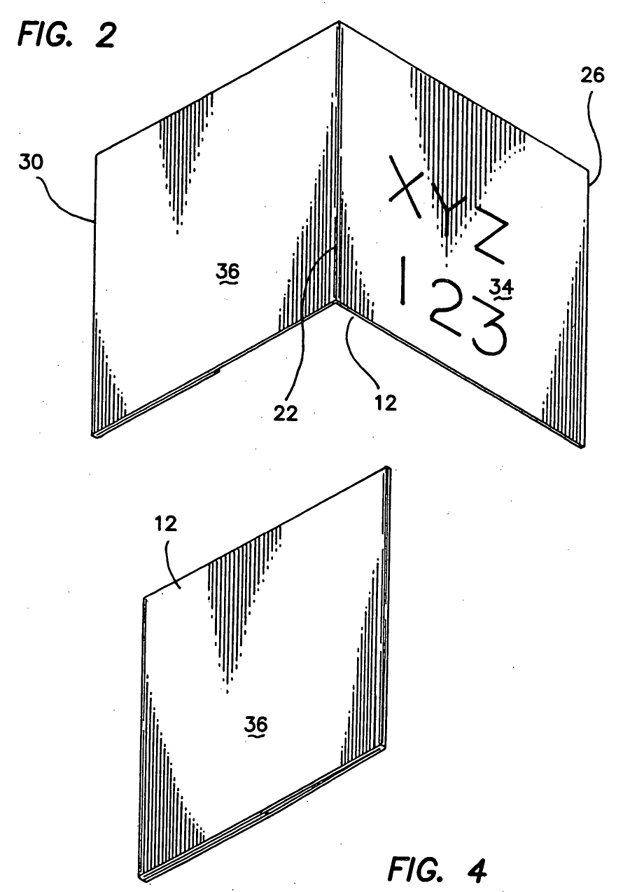

The front leaf 26 of the card 12 may be rotated about the folding line 22 to close the card 12 into a substantially planar side view, that is, substantially flat, as shown in FIGS. 3 and 4. The card 12 has a front outside surface 34 and a front inside surface 24 on which indicia and text may be printed. Indicia may also be imprinted on the surface of the pocket 14 and other surfaces, such as back leaf inside surface 28 and outside surface 36, as may be considered appropriate. The indicia, as representatively shown on surfaces 15, 24, 34 in FIGS. 1 and 3, generally is in the form of pictures and text that establish a theme for the card 12. Such a theme could be a greeting on the birth of a child, a condolence, an announcement, a congratulation for some event or milestone such as a marriage or graduation, an expression of good wishes or good fortune in the event of an illness, or the like.

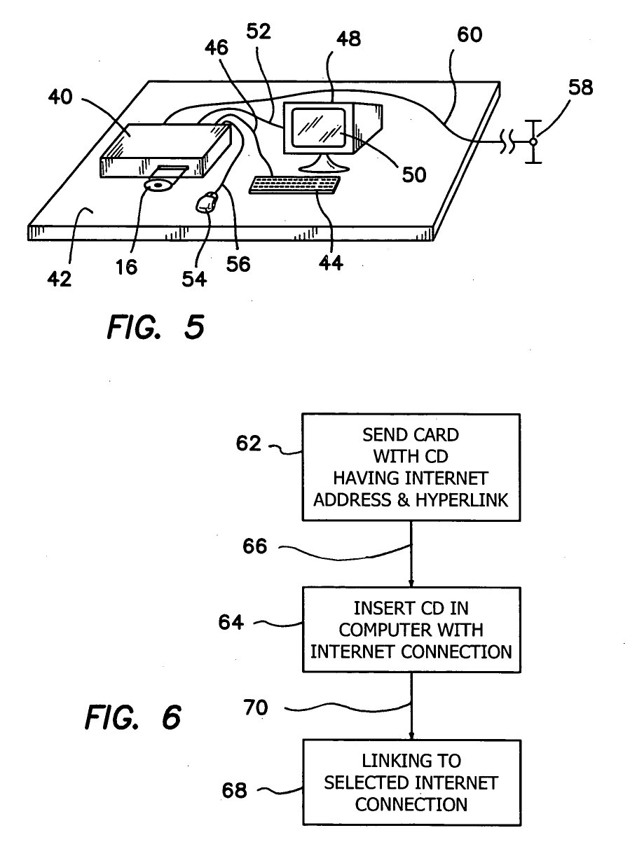

The card assembly 10 also comprises a disk 16 which can be removed from the disk pocket 14 by inserting a finger into the disk center hole 20 and sliding the disk 16 out of the pocket 14. The disk 16 will have embedded in memory thereon certain predetermined information or data that can be read by computers 40, as will explained in more detail in conjunction with FIG. 5 below. The information or data stored on the disk 16 will be related in subject matter to the theme established by the indicia on the surfaces 15, 24, 34 of the card 12.

Referring to FIG. 5, the disk 16 can be removed from the assembly 10 and inserted into the computer 40, which is conveniently situated on a table 42. The computer 40 is controlled by either a keyboard 44, which is connected to the computer 40 by keyboard connector 46, or is controlled by a “mouse” 54 connected to the computer 40 by mouse connector 56. A monitor 48 having a display screen 50 is also connected to the computer 40 by display connector 52. The information and data stored on the disk 16 can be “read” by the computer 40 and displayed in human readable format on the screen or monitor 50.

The computer 40 is also connected to the World Wide Web Internet 58 (Internet) through connector interface 60. The disk 16 also has stored in its memory, certain predetermined Internet addresses that, when the addresses are displayed on display 50, an operator may use the keyboard 44 or mouse 54 to “click” on a selected one of the displayed Internet addresses and be connected to a home page of the selected Internet address. The Internet addresses which will be included on the disk 16 will be addresses of Web Pages which have as their subject matter information, data, products and services which thematically correlate with the theme established by the indicia and text of the surfaces 15, 24, 34 of the card 12.

In operation, in the preferred embodiment of the present invention, a card assembly 10 having a card 12 and a disk 16 are sent 62, referring to the block diagram of FIG. 6 and progressing in the direction of the arrows 66, 70. The text and other indicia on the card 12 will have a theme which will correlate to the theme of the information stored on the disk 16. The disk 16 will also have embedded thereon certain Internet addresses which can be used to create or establish a hyperlink to predetermined home pages on the Internet 58. A recipient of the card assembly 10 then removes the disk 16 from the pocket 14 of the card 12, and inserts 64 the disk 16 into the computer 40. The information on the disk 16, having a common theme with the indicia and text on the surfaces 24, 34 of the card 12, is displayed on the display screen 50 of the monitor 48.

Also displayed on the display screen 50 will be one or more predetermined Internet addresses which can provide a hyperlink to corresponding home pages on the Internet 58. The next step will be a selection of one of these addresses by use of the mouse 54 or the keyboard 44, to establish a hyperlink to the selected Internet address on the Internet 58 through the connector 60.

The foregoing detailed description of my invention and of a preferred embodiment as to products, compositions and processes, is illustrative of specific embodiments only. It is to be understood, however, that additional embodiments may be perceived by those skilled in the art. The embodiments described herein, together with those additional embodiments, are considered to be within the scope of the present invention.

1. A method for interactively presenting at least one predetermined Internet address, comprising the steps of:
a) sending a card having indicia textually displayed thereon having a predetermined theme, and having an electronically readable data memory and address means for storing information data related to said theme, and for storing at least one predetermined Internet address, wherein said Internet address identifies a homepage having information related to said theme;
b) inserting said electronically readable data memory and address means into computer means for displaying in human readable format said information data related to said theme and for presenting said predetermined Internet address in interactive format, said computer means further comprising means for electronically connecting to the Internet and to at least one homepage identified by said at least one Internet address;
c) electronically selecting said Internet address and thereby connecting said computer means to said information related to said theme.

2. The method of claim 2 wherein in said sending a card step, said electronically readable data memory and address means further comprises a plurality of Internet addresses in interactive format, and wherein said computer means for electronically connecting to the Internet further comprises means for connecting to a plurality of homepages each identified by Internet addresses.

3. The method of claim 2, wherein in said electronically selecting step, selecting at least one of said Internet addresses and thereby connecting said computer means to at least one of said homepages having said information related to said theme.

4. The method of claim 3, wherein in said sending a card step and in said electronically selecting step, said Internet addresses identify homepages that have products and services for sale related to said theme.

5. An interactive presentation card assembly comprising in combination:
a) a card having thematic indicia textually displayed thereon having a predetermined theme;
b) an electronically readable data memory and address means for storing information data related to said theme, and for storing at least one predetermined Internet address, wherein said Internet address identifies a homepage having information data related to said theme; and,
c) computer means for displaying in human readable format said information data related to said theme and for presenting said predetermined Internet addresses in interactive format, said computer means further comprising means for electronically connecting to the Internet and to said at least one homepage identified by said at least one Internet addresses.

6. The interactive presentation card assembly of claim 5 wherein said electronically readable data memory and address means further includes a plurality of Internet addresses in interactive format, and wherein said computer means for electronically connecting to the Internet further comprises means for connecting to a plurality of homepages each identified by Internet addresses.

7. The interactive presentation card assembly of claim 5 wherein in said electronically readable data memory and address means, said Internet address identifies a homepage having products and services related to said theme and available for purchase over said Internet.
